(19) United States
(12) Patent Application Publication
(10) Pub. No.: US 2014/0013225 A1
(43) Pub. Date: Jan. 9, 2014

(54) DIGITAL MEDIA CONTROLLER AND METHOD FOR CONTROLLING A DIGITAL MEDIA SYSTEM

(71) Applicant: PEGATRON CORPORATION, Taipei City (TW)

(72) Inventors: Jih-Wei WU, Taipei City (TW); Po-Jen CHIU, Taipei City (TW)

(73) Assignee: PEGATRON CORPORATION, Taipei City (TW)

(21) Appl. No.: 13/837,534

(22) Filed: Mar. 15, 2013

(30) Foreign Application Priority Data
Jul. 6, 2012 (TW) 101124466

(51) Int. Cl. G06F 3/0481

(52) U.S. Cl. CPC G06F 3/04817
USPC 715/716

(57) ABSTRACT

A method for controlling a digital media system suitable for a digital media controller connecting to the digital media system. The method includes restarting a control mechanism to let the digital media controller enter into a digital media system. In the control mechanism, a previous digital media environment status is checked to see whether a plurality of digital media renderer information and a plurality of digital media server information recorded in the previous digital media environment status respectively correspond to the digital media renderers and the digital media servers under an available status. A digital media renderer icon corresponding to the digital media renderer information under the available status is shown as being under a renderer available status, and a digital media server icon corresponding to the digital media server information under the available status is shown as being under a server available status.

### CROSS REFERENCE TO RELATED APPLICATIONS

This Non-provisional application claims priority under 35 U.S.C. §119(a) on Patent Application No(s). 101124466 filed in Taiwan, Republic of China on Jul. 6, 2012, the entire contents of which are hereby incorporated by reference.

### BACKGROUND OF THE INVENTION

1. Technology Field

The disclosure relates to a method and a digital media controller for controlling a digital media system and, in particular, to a method for controlling a digital media system suitable for a digital media controller connecting to the digital media system

2. Related Art

DLNA (Digital Living Network Alliance) is an alliance organization consisting of companies selling consumer electronics, mobile phones, and computers. It defined unified transmission specifications for devices of different companies to be able to communicate with each other. Accordingly, multimedia devices can establish links, perform synchronized actions, or even transmit data directly as long as they conform to the DLNA specification.

DLNA devices are separated into four categories: DMS (Digital Media Server), DMP (Digital Media Player), DMC (Digital Media Controller), and DMR (Digital Media Renderer). Among those devices, a DMS is a device that obtains, records, stores and acts as the source of multimedia files. A DMP is a device that can search actively and play or output any multimedia file that is provided by a DMS. A DMC acts as a remote control device that can search the multimedia files on a DMS, designate the DMR capable of rendering the multimedia files to render them, and control the upload of the multimedia files to the DMS. A DMR can passively receive and play the multimedia file pushed from a DMC.

In a home network, any computer, mobile phone, server or player can share and play multimedia contents (such as videos, music or pictures) through the network as long as it conforms to the DLNA specification. Except for the source of the contents, a user can also select freely to play the multimedia file on any device that has playback capabilities. For example, a user can use the control computer in the kitchen to select the video in the computer in the study room and play it on the television screen in the living room. As a result, the convenience of a digital home to enjoy video and audio quickly and easily can be achieved.

### SUMMARY

The disclosure provides a method for controlling a digital media system, which can quickly resume the digital media environment status to improve the convenience of the user operations.

The disclosure provides a DMC which, when re-entering into a digital media system, can quickly resume the playback status of each DMR stored when the DMC exited from the digital media system, to improve the entertainment effect provided to a user.

The embodiment of the provides a method for controlling a digital media system suitable for a digital media controller connecting to the digital media system, the digital media system including a network, a plurality of digital media server, and a plurality of digital media renderer, the digital media controller connecting with the digital media servers and the digital media renderers through the network, the method comprising: checking whether a previous digital media environment status exists. When the previous digital media environment status exist, a plurality of digital media renderer information and a plurality of digital media server information recorded in the previous digital media environment status are checked according to the previous digital media environment status to see whether they respectively correspond to the digital media renderers and the digital media servers under an available status. A digital media renderer icon corresponding to each of the digital media renderer information under the available status is shown as being under a renderer available status, and a digital media server icon corresponding to each of the digital media server information under the available status is shown as being under a server available status.

In one embodiment of the invention, the step of showing the digital media server icon corresponding to each of the digital media server information under the available status as being under the server available status further comprises: showing a file list of a plurality of multimedia files stored in the digital media server corresponding to each of the digital media server information under the available status.

In one embodiment of the invention, the method for controlling the digital media system further comprises: when at least one of the digital media renderer information and the digital media server information recorded in the previous digital media environment status does not correspond to the digital media renderers and the digital media servers under the available status, showing each of the digital media renderer icons corresponding to each of the not corresponding digital media renderer information as being under a renderer unavailable status, and each of the digital media server icons corresponding to each of the not corresponding digital media server information as being under a server unavailable status.

In one embodiment of the invention, the step of showing each of the digital media server icons corresponding to each of the not corresponding digital media server information as being under the server unavailable status further comprises: marking a text message at the digital media server icon corresponding to each of the not corresponding digital media server information to indicate the server unavailable status.

In one embodiment of the invention, the method for controlling the digital media system further comprises: when the previous digital media environment status exists, resuming a digital media environment status setting of the digital media controller to the previous digital media environment status. A playback status corresponding to the renderer available status of the digital media renderer is shown on the digital media controller according to the digital media renderer information recorded in the previous digital media environment status.

In one embodiment of the invention, the digital media renderer information includes a digital media renderer identification code, a playback mode message, a playback file information, a volume information and a last playback time position information.

In one embodiment of the invention, the previous digital media environment status further records a file path in the DMS information corresponding to a played file in the DMR information.

In one embodiment of the invention, the method for controlling the digital media system further comprises: storing a current digital media environment status as the previous digital media environment status.

The invention also provides a digital media controller for connecting to a digital media system, the digital media system including a network, a plurality of digital media servers, and a plurality of digital media renderers, the digital media controller comprising: a signal transmitting interface, a display unit, a storage device and a processor. The signal transmitting interface is connected with the digital media servers and the digital media renderers through the network. The storage device stores a computer-executable program. The processor is coupled to the signal transmitting interface, the display unit and the storage device, and executing a plurality of instructions of the computer-executable programs. The instructions include checking whether a previous digital media environment status exists. When the previous digital media environment status exist, a plurality of digital media renderer information and a plurality of digital media server information recorded in the previous digital media environment status are checked according to the previous digital media environment status to see whether they respectively correspond to the digital media renderers and the digital media servers under an available status. A digital media renderer icon corresponding to each of the digital media renderer information under the available status is shown as being under a renderer available status, and a digital media server icon corresponding to each of the digital media server information under the available status is shown as being under a server available status.

In one embodiment of the invention, the instruction of showing the digital media server icon corresponding to each of the digital media server information under the available status as being under the server available status further comprises: showing a file list of a plurality of multimedia files stored in the digital media server corresponding to each of the digital media server information under the available status.

In one embodiment of the invention, the instructions further comprise: when at least one of the digital media renderer information and the digital media server information recorded in the previous digital media environment status does not correspond to the digital media renderers and the digital media servers under the available status, showing each of the digital media renderer icons corresponding to each of the not corresponding digital media renderer information as being under a renderer unavailable status, and each of the digital media server icons corresponding to each of the not corresponding digital media server information as being under a server unavailable status.

In one embodiment of the invention, the instruction of showing each of the digital media server icons corresponding to each of the not corresponding digital media server information as being under the server unavailable status further comprises: marking a text message at the digital media server icon corresponding to each of the not corresponding digital media server information to indicate the server unavailable status.

In one embodiment of the invention, the instructions further comprises: when the previous digital media environment status exists, resuming a digital media environment status setting of the digital media controller to the previous digital media environment status. A playback status corresponding to the renderer available status of the digital media renderer is shown on the digital media controller according to the digital media renderer information recorded in the previous digital media environment status.

In one embodiment of the invention, in the digital media controller, the digital media renderer information includes a digital media renderer identification code, a playback mode message, a playback file information, a volume information and a last playback time position information.

In one embodiment of the invention, in the digital media controller, the previous digital media environment status further records a file path in the digital media server information corresponding to a played file in the digital media renderer information.

In one embodiment of the invention, in the digital media controller, the instructions further comprises: storing a current digital media environment status as the previous digital media environment status.

Based on the above, according to the digital media server information and the digital media renderer information stored in the previous digital media environment status, when the digital media controller re-enters the digital media system, the digital media renderer information corresponding to the digital media server icon shown on the digital media controller (including the final playback status) can be resumed to the previous final status, and the digital media server information corresponding to the digital media server icon shown on the digital media controller can be resumed to the previous final status. Therefore, when re-entering the digital media system, the digital media controller can quickly resume of each digital media renderer to the playback status when the digital media controller exited form the digital media system previously. The user does not need to spend time and effort to reset the digital media environment status, which enhances the convenience and the entertainment effect for the user.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a flowchart showing a method for controlling a digital media system according to an embodiment of the invention;

FIG. 2 is a schematic diagram of a multimedia system;

FIG. 3 is a schematic diagram showing a control interface of the digital media system shown on the display unit of the digital media controller (DMC) according to an embodiment of the invention;

FIG. 4 is a schematic diagram showing a control interface of the digital media system shown on the display unit of the digital media controller (DMC) according to another embodiment of the invention;

FIG. 5 is a flowchart of the method for controlling a digital media system according to still another embodiment of the invention; and

FIG. 6 is a schematic diagram of a DMC according to an embodiment of the invention.

### DETAILED DESCRIPTION OF THE INVENTION

The present invention will be apparent from the following detailed description, which proceeds with reference to the accompanying drawings, wherein the same references relate to the same elements.

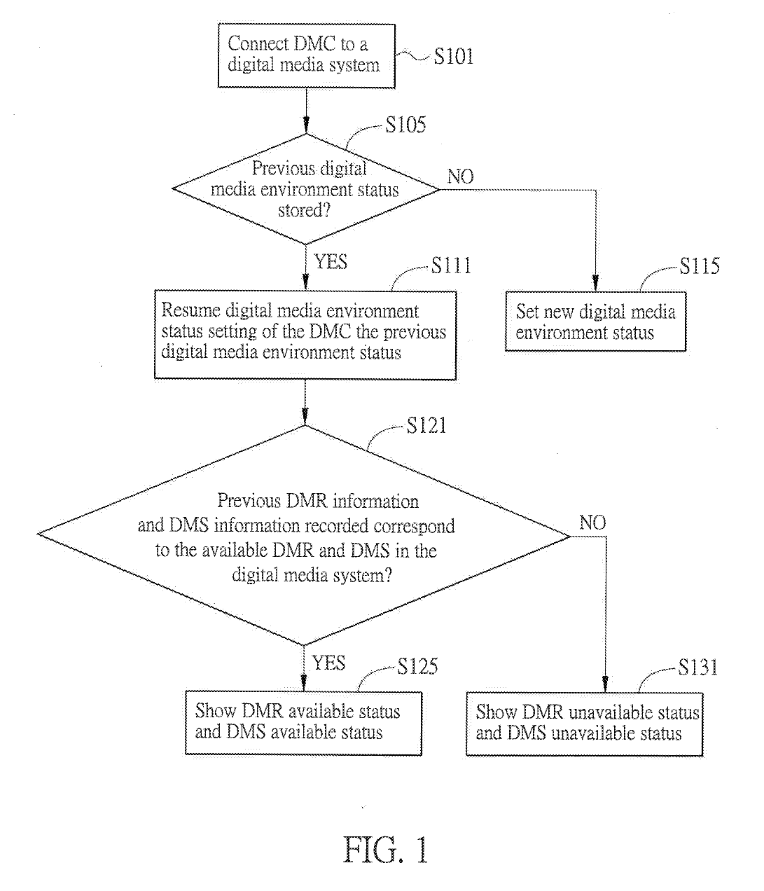

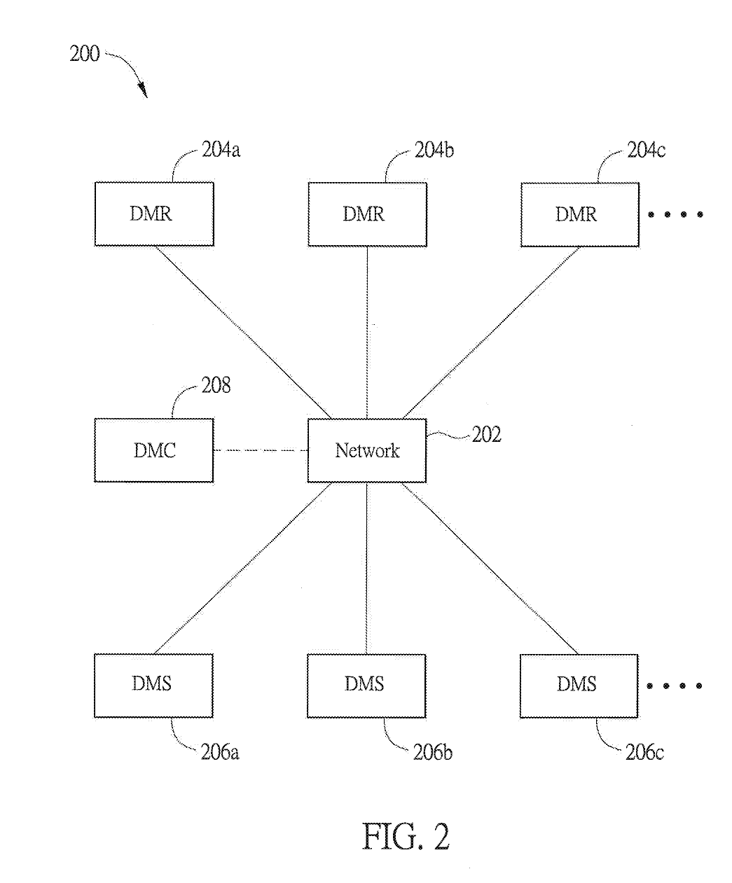

FIG. 1 illustrates the flowchart of the method for controlling a digital media system according to an embodiment of the invention. In the present embodiment, the method for controlling a digital media system is executed by a DMC (Digital Media Controller) 208 (as shown in FIG. 2) connected to a digital media system 200. The DMC 208 is a DLNA-complaint portable electronic device with a display unit, such as a tablet PC, a smart phone or a personal digital assistant. Referring to FIG. 1, in step 5101, the DMC 208 connects to a digital media system 200 (as shown in FIG. 2). FIG. 2 is a schematic diagram showing a multimedia system. Referring to FIG. 2, the digital media system 200 includes a network 202, a plurality of DMRs (Digital Media Renderers) (at least including DMRs 204a, 204b and 204c) and a plurality of DMSs (Digital Media Servers) (at least including DMSs 206a, 206b and 206c). Each of the DMSs 206a˜206c stores a plurality of multimedia files. In step S101, the DMC 208 connects to the DMSs (at least including DMSs 206a, 206b and 206c) and the DMRs (at least including DMRs 204a, 204b and 204c) respectively through the network 202.

Furthermore, the network 202 is for example connects the DMRs 204a˜204c, the DMSs 206a˜206c and the DMC 208 in a wired or wireless manner. Moreover, the network 202 is for example an Ethernet network, an IEEE 1394-based network, an IEEE 802.11-based wireless network, or a combination of the networks above.

The DMSs above are hardware apparatuses that can provide DLNA audio and video server functionalities, such as personal computers, network storage medium, digital recorders or portable electronic devices (including notebook computers, mobile phones, personal digital assistants and digital cameras) that are DLNA-complaint. The DMRs above are hardware apparatuses that can provide DLNA audio and video playback capabilities, such as TVs, stereo acoustic systems, personal computers or portable electronic devices (including notebook computers, mobile phones, personal digital assistants and digital cameras) that are DINA-complaint. Moreover, the multimedia files above are for example video files, audio tiles or picture files.

Subsequently, please refer to FIGS. 1 and 2. In step S105, DMC 208 is checked to see whether any previous digital media environment status exists. A previous digital media environment status is, for example, the corresponding digital media environment status of the digital media system which the DMC 208 is within before the DMC 208 terminates its connection with the digital media system 200, including the DMR information (including the DMR identification code and the last playback status) of each DMR in the digital media system, the DMS information of each DMS in the digital media system, and the file path in the DMS information corresponding to the played file in the DMR information (that is, the file path of the played file of each DMR in the DMS). The last playback status mentioned above includes the playback mode information, the playback file information, the volume information and the last playback time position information.

Once confirmed that the previous digital media environment status exists in the DMC 208, a digital media environment status setting of the DMC 208 is resumed to the previous digital media environment status (step S111). Alternatively, once confirmed that there is no previous digital media environment status is stored in the DMC 208, then a digital media environment status is newly set (step S115). That is, the DMC 208 searches the DMRs 204a˜204c and the DMSs 206a˜206c, and records the multimedia files stored in each of the DMSs 206a˜206c, the individual information of each of the DMSs 206a˜206c (that is, the DMS information), and the individual information of each of the DMRs 204a˜204c (that is, the DMR information) to newly set a digital media environment status.

After the step S111 which resumes the digital media environment status setting of the DMC 208 back to the previous digital media environment status, in step S121 the previous digital media environment status is checked to see whether a plurality of the DMR information and a plurality of the DMS information recorded correspond to the available DMRs 204a˜204c and DMSs 206a˜206c in the digital media system 200. That is, when one of the plurality of the DMR information recorded in the previous digital media environment status corresponds to one of the DMSs 206a˜206c in the digital media system 200, then it is confirmed that this DMR information is under an available status. Similarly, when one of the plurality of the DMS information recorded in the previous digital media environment status corresponds to one of the DMSs 204a˜204c in the digital media system 200, then it is confirmed that this DMS information is under an available status.

When it is confirmed that at least a portion of the DMR information is under an available status and at least a portion of the DMS information is under an available status (that is, at least a portion of the DMR information corresponds to the DMR in the digital media system, and at least a portion of the DMS information corresponds to the DMS in the digital media system), the DMR icon corresponding to the DMR information under an available status is shown as a renderer available status, and the DMS icon corresponding to the DMS information under an available status is shown as a server available status (step S125).

However, when it is confirmed that one of the DMR information is not corresponding and/or one of the DMS information is not corresponding (that is, at least one of the DMR information recorded in the previous digital media environment status does not correspond to any DMR, or at least one of the DMS information recorded in the previous digital media environment status does not correspond to any DMS), the DMR icon of each of the not-corresponding DMR information is shown as a renderer unavailable status, and the DMS icon of each of the not-corresponding DMS information is shown as a server unavailable status (step S131).

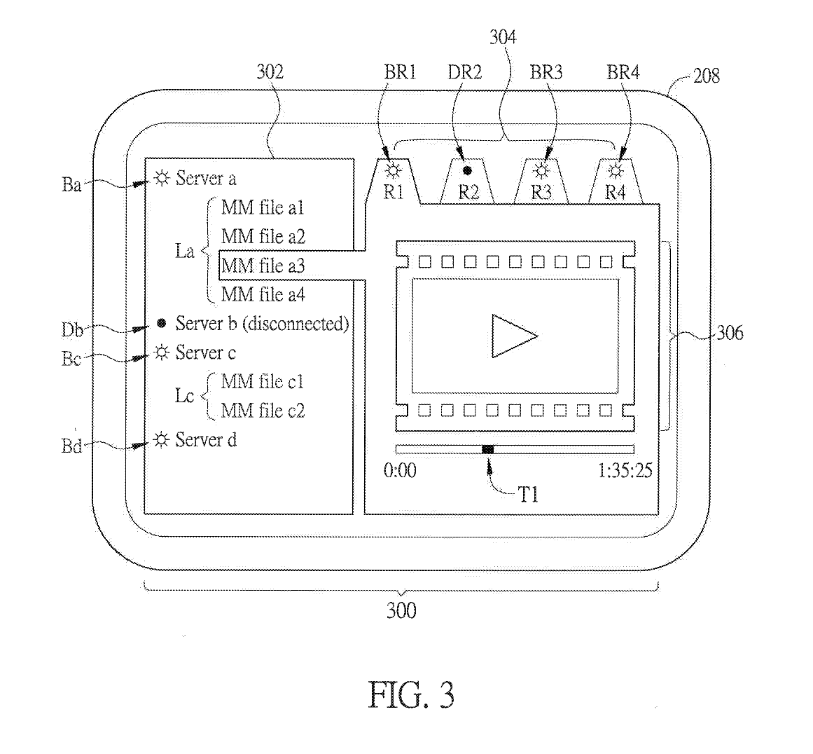

FIG. 3 is a schematic diagram showing a control interface of the digital media system shown on the display unit of the DMC according to an embodiment of the invention. Referring to FIG. 2 and FIG. 3, in the method for controlling the digital media system according to the embodiment, after the DMC 208 is connected with the digital media system 200, a digital media environment status 300 is shown on the display unit of the DMC 208. This digital media environment status 300 includes a DMS list 302 and a DMR list 304.

The DMS list 302 lists the DMS icons corresponding to the DMSs that have been recorded to be connected with the DMC 208 (including “Server a”, “Server b”, “Server c”, and “Server d”). Wherein each of the DMS icons corresponds to a DMS information, respectively. For example, if the digital media environment status 300 shown on the display unit of the DMC 208 is the resumed previous digital media environment status (as described in step S111 previously), the DMS information respectively corresponding to each DMS icon is the DMS information recorded in the previous digital media environment status (that is, the last status information of the DMS before the end of the connection between the DMC 208 and the digital media system 200). If the digital media environment status 300 is a newly set digital media environment status (as described in step S115 previously), the DMS information respectively corresponding to each DMS icon is the individual information of the DMS and the multimedia file stored in each DMS recorded in the current digital media environment status newly set for the digital media system 200 which the DMC 208 is within. In the DMS list 302 shown in FIG. 3, the DMS in the digital media environment status 300 is represented by a textual icon. However, the invention is not limited by this. That is, the DMS icon in the DMS list 302 corresponding to the DMS information may be any representing image, text, symbol, or alphanumeric.

Similarly, the DMR list 304 lists the DMR icons corresponding to the DMRs that have been recorded to be connected with the DMC 208 (including R1, R2, R3 and R4). Wherein each of the DMR icons corresponds to a DMR information, respectively. For example, if the digital media environment status 300 shown on the display unit of the DMC 208 is the resumed previous digital media environment status (as described in step S111 previously), the DMR information respectively corresponding to each DMR icon is the DMR information recorded in the previous digital media environment status (that is, the last status information of the DMR before the end of the connection between the DMC 208 and the digital media system 200). If the digital media environment status 300 is a newly set digital media environment status (as described in step S115 previously), the DMR information respectively corresponding to each DMR icon is the individual information of the DMR recorded in the current digital media environment status newly set for the digital media system 200 which the DMC 208 is within. In the DMR list 304 shown in FIG. 3, the DMR in the digital media environment status 300 is represented by a textual icon. However, the invention is not limited by this. That is, the DMR icon in the DMR list 304 corresponding to the DMR information may be any representing image, text, symbol, or alphanumeric.

After checked whether the DMR information and the DMS information recorded in the previous digital media environment status respectively correspond to the DMR and DMS in the digital media system 200 in step S121, the digital media environment status 300 shown by the display unit of the DMC 208 shows the DMR icon of each DMR information in the available status as a renderer available status, and the DMS icon of each DMS information in the available status as a server available status (as described in step S125 previously). As shown in FIG. 3, in the digital media environment status 300 shown by the display unit, a bright dot (such as those marked as Ba, Bc and Bd) is shown beside the DMS icon (including “Server a”, “Server c” and “Server d”) corresponding to the DMS information in the available status representing that they are in a server available status. A bright dot (such as those marked as BR1, BR3 and BR4) is shown beside the DMR icon (including “R1”, “R3” and “R4”) corresponding to the DMR information in the available status representing that they are in a renderer available status.

Furthermore, after step S121, in the digital media environment status 300 shown by the display unit of the DMC 208, the DMR icon corresponding to the not-corresponding DMR information is marked as in a renderer unavailable status, and the DMS icon corresponding to the not-corresponding DMS information is marked as in a server unavailable status. As shown in FIG. 3, in the digital media environment status 300 shown by the display unit, a dark dot (such as the dark dot marked as Db) is shown beside the DMS icon (including “Server b”) corresponding to the not-corresponding DMS information representing that it is in a server unavailable status. A dark dot (such as the dark dot marked as DR2) is shown beside the DMR icon (R2) corresponding to the not-corresponding DMR information representing that it is in a renderer unavailable status. In the embodiment shown in FIG. 3, a bright dot is used to show the icons corresponding the DMS information and DMR information as in the available status, and a dark dot is used to show the icons corresponding the DMS information and DMR information as in the unavailable status. However, the invention is not limited therein. That is, the marks showing the corresponding DMS/DMR information as in the available status and not-corresponding may be any type of mark, such as image marks, textual marks, symbol marks or alphanumeric marks.

Moreover, in the embodiment shown in FIG. 3, the marking of the DMS icon corresponding to each DMS information in the server available status further includes showing a file list of the plurality of multimedia files stored by the DMS corresponding to each DMS information. As shown in FIG. 3, beside the DMS icons (including “Server a” and “Server c”) marked as being in the server available status by bright dots Ba and Bc, file lists La and Lc corresponding to the files stored in the DMSs in the digital media system 200 are listed.

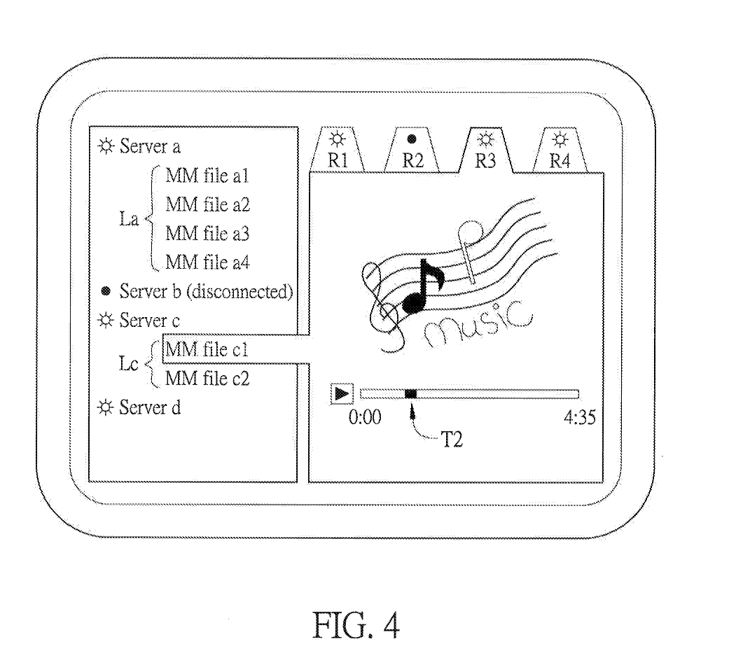

FIG. 4 is a schematic diagram showing the control interface shown on the display unit of a DMC according to another embodiment of the invention. It is noteworthy that the same elements in FIG. 3 and FIG. 4 are indicated by the reference numbers, and relevant explanations are omitted here for concise purpose. In the embodiment shown in FIG. 4, the marking of the DMS icon corresponding to the DMS information as not-corresponding further including marking a text message on the DMS icon corresponding to the not-corresponding DMS information to prompt to a user the server unavailable status of each not-corresponding DMS information. As shown in FIG. 4, beside the DMS icon marked as being in the server unavailable status by the dark dot Db, a text message “nc” (which means “not connected”) is marked to prompt to the user the server unavailable status of the not-corresponding DMS information.

Moreover, after the step Sill of resuming the digital media environment status setting of the DMC back to the previous digital media environment status, the method further includes displaying a playback status corresponding to the DMR icon marked as being in the renderer available status on the display unit of DMC 208 according to the DMR information recorded in the previous digital media environment status. Referring to FIG. 3, the DMR icon RI marked as being in the renderer available status shows in a preview region 306 a playback status of the DMR corresponding to the DMR icon R1 before last time the DMC terminated its connection to the digital media system (that is, the last playback status). That is, the DMR corresponding to the DMR icon R1 was playing the multimedia file a3 (such as a video file) before the DMC terminated its connection to the digital media system. In another embodiment, previous last playback status of the DMR corresponding to the DMR icon R1 shown in the preview region 306 of the display unit further includes showing a last playback tune position T1 of the playback of the multimedia file a3.

Referring to FIG. 4, the DMR corresponding to the DMR icon R3 was playing the multimedia file c1 (such as an audio file) provided by the DMS corresponding to the DMS icon “Server c” before last time the DMC terminated its connection with the digital media system. Moreover, the previous last playback status of the DMR corresponding to the DMR icon R3 displayed in the preview region 306 of the display unit further includes playing the multimedia file c1 to a last playback time position T2.

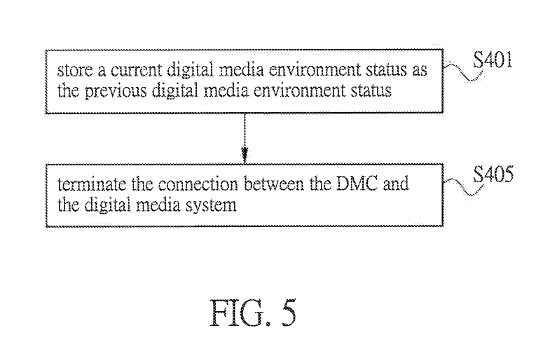

FIG. 5 is a flowchart showing a method for controlling a digital media system according to still another embodiment of the invention. Referring to FIG. 5, under the status that the DMC 208 connects to the DMS (at least including DMSs 206a, 206b and 206c) and DMR (at least including DMRs 204a, 204b and 204c) via the network 202, the method for controlling the digital media system according to the embodiment further includes storing a current digital media environment status as the previous digital media environment status in step S401. The definition is similar to the definition of the previous digital media environment status mentioned in the description of step S105 (i.e., the DMC 208 stores the current digital media environment status corresponding to the digital media system before the previous termination of the connection between the DMC and the digital media system). Subsequently, in step S405, the DMC 208 terminates its connection with the digital media system 200.

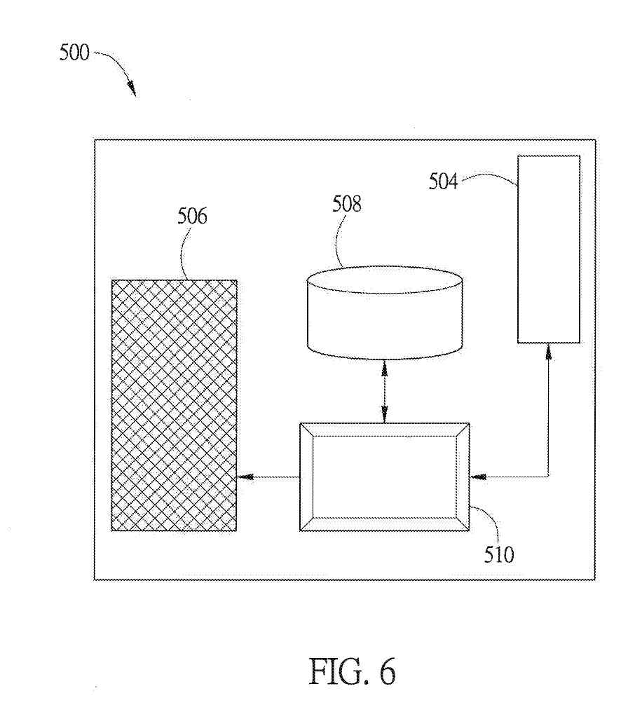

The method for controlling the digital media system in the above-mentioned embodiment may also be implemented by executing a computer-executable program on the DMC. FIG. 6 is a schematic diagram showing a DMC according to an embodiment of the invention. Referring to FIG. 6, in the present embodiment, DMC 500 includes a signal transmitting interface 504, a display unit 506, a storage device 508, and a processor 510. The signal transmitting interface 504 is connected with a DMC and a DMR through a network, respectively. The storage device 508 can store a computer-executable program. The processor 510 is coupled with the signal transmitting interface 504, the display unit 506 and the storage device 508, and executes a plurality of instructions of the computer-executable program. These instructions include: checking whether the previous digital media environment status exists in the storage device 508 of the DMC 500 (for details, see the step S105 of the embodiment described previously). When confirmed that the previous digital media environment status exists in the DMC 500, a digital media environment status setting of the DMC 500 is resumed to the previous digital media environment status (for details, see the step S111 of the embodiment described previously), otherwise a new digital media environment status is set (for details, see the step S115 of the embodiment described previously). The DMR information and DMS information recorded in the previous digital media environment status are checked to see if they are corresponding to the DMR and DMS in the digital media system, respectively (for details, see the step S121 of the embodiment described previously). When the DMR information and the DMS information correspond to the DMR and DMS of the digital media system, respectively, the DMR icon corresponding to each DMR information shown as being under an available status on the display unit 506 is shown as being under a renderer available status, and the DMS icon corresponding to each DMS information shown as being under an available status on the display unit 506 is shown as being under a server available status. To the contrary, the DMR icon corresponding to each DMR information shown as not corresponding on the display unit 506 is shown as being under a renderer unavailable status, and the DMS icon corresponding to each DMS information shown as not corresponding on the display unit 506 is shown as being under a server unavailable status (for details, see the step S131 of the embodiment described previously).

Furthermore, under the status that the DMC 208 is still connecting with the DMS and DMR through the network 202, the instructions of the computer-executable program of the present embodiment further includes: storing the current digital media environment status in the storage device as the previous digital media environment status (for details see the step S401 of the embodiment described previously), and terminating the connection between the DMC 208 and the digital media system 200 (for details see the step S405 of the embodiment described previously).

The method of showing each DMR icon as being under the renderer available status or unavailable status and showing each DMS icon as being under the server available or unavailable status and the further display details (including showing a playback status corresponding to the DMR icon being under the renderer available status on the display unit 506) has been described in detail in the previous embodiment, and therefore is not described here for concise purpose.

In the present invention, according to the DMS information and the DMR information stored in the previous digital media environment status, when the DMC reenters the digital media system, the DMR information corresponding to the DMS icon shown on the DMC (including the final playback status) can be resumed to the previous final status, and the DMS information corresponding to the DMS icon shown on the DMC can be resumed to the previous final status. Therefore, when re-entering the digital media system, the DMC can quickly resume of each DMR to the playback status when the DMC exited form the digital media system previously. The user does not need to spend time and effort to reset the digital media environment status, which enhances the convenience and the entertainment effect for the user.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for controlling a digital media system suitable tier a digital media controller connecting to the digital media system, the digital media system including a network, a plurality of digital media server, and a plurality of digital media renderer, the digital media controller connecting with the digital media servers and the digital media renderers through the network, the method comprising:
checking whether a previous digital media environment status exists;
when the previous digital media environment status exist, checking a plurality of digital media renderer information and a plurality of digital media server information recorded in the previous digital media environment status according to the previous digital media environment status to see whether they respectively correspond to the digital media renderers and the digital media servers under an available status; and
showing a digital media renderer icon corresponding to each of the digital media renderer information under the available status as being under a renderer available status, and showing a digital media server icon corresponding to each of the digital media server information under the available status as being under a server available status.

2. The method for controlling the digital media system according to claim 1, wherein the step of showing the digital media server icon corresponding to each of the digital media server information under the available status as being under the server available status further comprises:
showing a file list of a plurality of multimedia files stored in the digital media server corresponding to each of the digital media server information under the available status.

3. The method for controlling the digital media system according to claim 1, further comprising:
when at least one of the digital media renderer information and the digital media server information recorded in the previous digital media environment status does not correspond to the digital media renderers and the digital media servers under the available status, showing each of the digital media renderer icons corresponding to each of the not corresponding digital media renderer information as being under a renderer unavailable status, and each of the digital media server icons corresponding to each of the not corresponding digital media server information as being under a server unavailable status.

4. The method for controlling the digital media system according to claim 3, wherein the step of showing each of the digital media server icons corresponding to each of the not corresponding digital media server information as being under the server unavailable status further comprises:
marking a text message at the digital media server icon corresponding to each of the not corresponding digital media server information to indicate the server unavailable status.

5. The method for controlling the digital media system according to claim 1, further comprising:
when the previous digital media environment status exists, resuming a digital media environment status setting of the digital media controller to the previous digital media environment status;
showing a playback status corresponding to the renderer available status of the digital media renderer on the digital media controller according to the digital media renderer information recorded in the previous digital media environment status.

6. The method for controlling the digital media system according to claim 1, wherein the digital media renderer information includes a digital media renderer identification code, a playback mode message, a playback file information, a volume information and a last playback time position information.

7. The method for controlling the digital media system according to claim 1, wherein the previous digital media environment status further records a file path in the DMS information corresponding to a played file in the digital media renderer information.

8. The method for controlling the digital media system according to claim 1, further comprising:
storing a current digital media environment status as the previous digital media environment status.

9. A digital media controller for connecting to a digital media system, the digital media system including a network, a plurality of digital media servers, and a plurality of digital media renderers, the digital media controller comprising:
a signal transmitting interface for connecting with the digital media servers and the digital media renderers through the network;
a display unit;
a storage device storing a computer-executable program; and
a processor coupling to the signal transmitting interface, the display unit and the storage device, and executing a plurality of instructions of the computer-executable programs, wherein the instructions including:
checking whether a previous digital media environment status exists;
when the previous digital media environment status exist, checking a plurality of digital media renderer information and a plurality of digital media server information recorded in the previous digital media environment status according to the previous digital media environment status to see whether they respectively correspond to the digital media renderers and the digital media servers under an available status; and
showing a digital media renderer icon corresponding to each of the digital media renderer information under the available status as being under a renderer available status, and showing a digital media server icon corresponding to each of the digital media server information under the available status as being under a server available status.

10. The digital media controller according to claim 9, wherein the instruction of showing the digital media server icon corresponding to each of the digital media server information under the available status as being under the server available status further comprises:
showing a file list of a plurality of multimedia files stored in the digital media server corresponding to each of the digital media server information under the available status.

11. The digital media controller according to claim 9, wherein the instructions further comprise:
when at least one of the digital media renderer information and the digital media server information recorded in the previous digital media environment status does not correspond to the digital media renderers and the digital media servers under the available status, showing each of the digital media renderer icons corresponding to each of the not corresponding digital media renderer information as being under a renderer unavailable status, and each of the digital media server icons corresponding to each of the not corresponding digital media server information as being under a server unavailable status.

12. The digital media controller according to claim 11, wherein the instruction of showing each of the digital media server icons corresponding to each of the not corresponding digital media server information as being under the server unavailable status further comprises:
marking a text message at the digital media server icon corresponding to each of the not corresponding digital media server information to indicate the server unavailable status.

13. The digital media controller according to claim 9, wherein the instructions further comprise:
when the previous digital media environment status exists, resuming a digital media environment status setting of the digital media controller to the previous digital media environment status;
showing a playback status corresponding to the renderer available status of the digital media renderer on the digital media controller according to the digital media renderer information recorded in the previous digital media environment status.

14. The digital media controller according to claim 9, wherein the digital media renderer information includes a digital media renderer identification code, a playback mode message, a playback file information, a volume information and a last playback time position information.

15. The digital media controller according to claim 9, wherein the previous digital media environment status further records a file path in the digital media server information corresponding to a played file in the digital media renderer information.

16. The digital media controller according to claim 9, wherein the instructions further comprise:
storing a current digital media environment status as the previous digital media environment status.
